(19) United States
(12) Patent Application Publication
(10) Pub. No.: US 2007/0118792 A1
(43) Pub. Date: May 24, 2007

(54) Selecting and pricing advertising for passed-along content

(75) Inventors: Michael O'Donnell, Sammamish, WA (US); Jonathan Peterson, Evanston, IL (US)

Correspondence Address: GRAYBEAL, JACKSON, HALEY LLP, 155 - 108TH AVENUE NE, SUITE 350, BELLEVUE, WA, 98004-5901, US

(73) Assignee: iCopyright, Inc.

(21) Appl. No.: 11/599,243

(22) Filed: Nov. 13, 2006

Related U.S. Application Data
(60) Provisional application No. 60/735,347, filed on Nov. 10, 2005.
(60) Provisional application No. 60/774,110, filed on Feb. 16, 2006.

(51) Int. Cl. G06F 17/00; G06Q 30/00; G06F 3/00

(52) U.S. Cl. 715/501.1; 705/26; 715/764

(57) ABSTRACT

A method for selecting and pricing advertising to accompany published digital content and printed copies of such content that people pass along to others via e-mail, print, blogs, RSS feeds, websites, hardcopy, and other distribution and republishing mediums. Ads placed in the passed-along content will typically be different from, and more relevant than, ads that were displayed with the content when it was presented to the first reader—who then decided to pass it along, and therefore the ads may be billed out by the publisher at a higher price because they now have greater value.

### BACKGROUND

Before the advent of the Internet and digital content, people physically passed along entire books, newspapers, magazines, VHS and cassette tapes, CDs, DVDs, and other published collections, to their family, friends and associates. Today, for digital content published on the Internet, it is common for them to electronically pass along specific chapters, excerpts, articles, songs, photographs, and video clips. It is also common for people to make hardcopies of content found in digital form for distribution to others.

Many online publishers want consumers to electronically share their content with other people. News and information publishers often encourage people to e-mail the content, print the content, save or archive the content in digital reading rooms, and otherwise pass the content along to others who may be interested in it. Other types of publishers also employ these techniques. For example, music publishers make it easy for people to share demo recordings with others. Movie publishers make it easy for people to share film trailers with others. Photographers make it easy for people to share sample photographs with others.

When people pass along content to others in these ways, the shared content typically receives greater attention by the receiver than equivalent content that was not passed along, and the person who made the decision to pass it along is likely to look at it again with focused attention. Therefore, having the passed-along content viewed by the sender and the recipient is more valuable to the publisher and to any advertiser with an ad riding on the content because it is more likely to be seen or heard and paid attention to.

Some users cut, copy, and paste content, then pass it on to others without permission. Some users use the print function in the browser to make copies of content they find on the Internet and get through digital devices. Some do so with explicit or implied permission from the publisher. In fact, many online publishers provide tools that make it easy for their users to pass the content on to others. Advertisements are sometimes included with the passed-along content, but these ads may not be relevant to the content or targeted to the people that it is passed along to.

### SUMMARY OF THE INVENTION

In one embodiment, the invention makes it possible for publishers to include highly relevant and highly targeted advertisements with the passed-along content. These ads will typically be different from, and more relevant than, ads that were displayed with the content when it was presented to the first reader—who then decided to pass it along, and therefore the ads may be billed out by the publisher at a higher price because they now have greater value. Thus, publishers are able to earn more revenue from advertisers when their content is passed along.

In another embodiment, the invented method allows information about the passing along of content to be gathered and used to assess the advertising value of the content. For example, if a number of people pass along to others a link for viewing the content, or make a specific number of hardcopies, and the publisher knows about each pass along and the number of hardcopies, the publisher can charge a higher price for ads that are subsequently presented when the content is viewed by others.

In one aspect, the invention is a computer method for selecting advertising to accompany digital content published in a computer network system where users may pass along content to others. An item of digital content is published on a publicly accessible computer network with a first accompanying advertisement having a price. A system on the network receives from a first user on the network, which user had previously received a copy of the item with the first advertisement, a request to convey a copy of the item to a second person. The system conveys the item to the second person without the first advertisement and with a second advertisement in its place and charges for the second advertisement a different price than the first advertisement.

The copy may be conveyed by the first user requesting that a link to the item be conveyed over the network to a computer for the second person and the second person then receives the item as a result of selecting the link. The copy may be conveyed by the system conveying a message containing the item over the network to a computer for the second person. The copy may be conveyed by the system making a copy of the item available on a web page served by the system, which web page is associated with the first user, and then sending a message to the second person stating that one or more items selected by the first user are available from the web page. In this case, the message may be sent to the second person by the first user or the message may be sent to the second person by the system.

The copy may be conveyed to the second person by printing one or more copies on paper and sending the paper copies. The first user may instruct the system to wait for a specified period of time and then convey a copy of the content to the second person.

The second advertisement typically has a higher price than the first advertisement. However, there are situations where the second advertisement will have a lower price than the first advertisement, such as where the second person is identified and is considered a lower value target than the average reader of the originally published content.

The price for the second advertisement may be set in part as a function of information stored in the system about the first user or the second person or both.

In another aspect, the invention is a computer method for pricing advertising to accompany digital content published in a computer network system where users may pass along content to others. The system publishes an item of digital content on a publicly accessible computer network with an accompanying advertisement having a first price charged to an advertiser for presentation of the advertisement. Then the system receives a request from a user on the network to convey a copy of the item to a second person. The system conveys a copy of the item to the second person with the advertisement and charges to the advertiser a second price for presentation of the advertisement which second price is different than the first price.

A number of one or more requests are received, each requesting that a copy of the item be conveyed to one or more other people, and the second price may in part be set as a function of the number of requests received. The price for advertisement presentation may be based in part on the number of hardcopies to be printed. The price for advertisement presentation may be based in part on sending the ad to a computer for viewing (an “impression”). The price for advertisement presentation may be based in part on selection of the ad by a computer user (a “click”). The second price for advertisement presentation may be based in part on one or both of: length of time the item was saved in the system for access by the first user and number of viewings by the first user before the first user instructs the system to convey the item to the second user.

In another aspect, the invention is a computer method for pricing advertising to accompany digital content published in a computer network system where users may pass along content to others based on identity of the sender. An item of digital content is published on a publicly accessible computer network. The system receives a request from a first user on the network to convey a copy of the item to a second person. The system looks up in a database an identity of the first user. The system then conveys a copy of the item to the second person with an advertisement and automatically charges to an advertiser a price for presentation of the advertisement which price is a function of the identity of the first user.

The identity of the first user may be established from logon information entered to the network by the first user. The identity of the first user may be established from a cookie stored in a computer used by the first user to access the network. The identity of the first user may be established from a network address used by the first user.

The price for advertisement presentation may be based in part on a profile of the first user which profile was assembled from data about content items that have been acted upon previously by the first user. The profile may have been assembled by identifying content that was previously passed along by the first user. The content may have been identified by identifying the publisher and publication. The content may have been identified by identifying a particular subject addressed in a particular item of content previously passed along by the first user. The profile may have been assembled by identifying advertisements that were previously selected by the first user.

In another aspect, the invention is a computer method for selecting advertising to accompany digital content published in a computer network system where users may pass along content to others based on identity of the first user. The system publishes an item of digital content on a publicly accessible computer network and then receives a request from a first user on the network to convey a copy of the item to a second person. The system looks up in a database an identity of the first user; and then conveys a copy of the item to the second person with an advertisement and automatically selects the advertisement as a function of the identity of the first user.

In another aspect, the invention is a computer method for pricing advertising to accompany digital content published in a computer network system where users may pass along content to others based on identity of the second person. The system publishes an item of digital content on a publicly accessible computer network; receives a request from a first user on the network to convey a copy of the item to a second person; looks up in a database an identity of the second person; and conveys a copy of the item to the second person with an advertisement and automatically charges to an advertiser a price for presentation of the advertisement which price is a function of the identity of the second person.

The item may be conveyed to a network address and the identity of the second person may be established from logon information entered to the network associated with the network address, or the identity of the second person may be established from a cookie stored in a computer used by the second person to access the network, or the identity of the second person may be established from the network address itself. Finally, the identity of the second person may established by the first user identifying the second person by one or more of name, title, company, address, department, function, or relationship.

The copy may be conveyed to the second person by printing one or more copies on paper and sending the paper copies.

The price for advertisement presentation may be based on a profile of the second person which profile was assembled from data about content items that have been acted upon previously by the second person. The profile may be assembled by identifying content that was previously passed along by the second person. The content may have been identified by identifying the publisher and publication. The content may have been identified by identifying a particular subject addressed in a particular item of content previously passed along by the second person. The profile may have been assembled by identifying advertisements that were previously selected by the second person.

In another aspect, the invention is a computer method for selecting advertising to accompany digital content published in a computer network system where users may pass along content to others where the advertisement is selected as a function of the identity of the recipient. The system publishes an item of digital content on a publicly accessible computer network and then receives a request from a computer on the network with a first computer network address to convey a copy of the item to a second person. The system looks up in a database an identity of the second person; and conveys a copy of the item to the second person with an advertisement, automatically selecting the advertisement as a function of the identity of the second person.

### BRIEF DESCRIPTION OF THE FIGURES

FIG. 1 illustrates the basic components of the invention.

### DETAILED DESCRIPTION

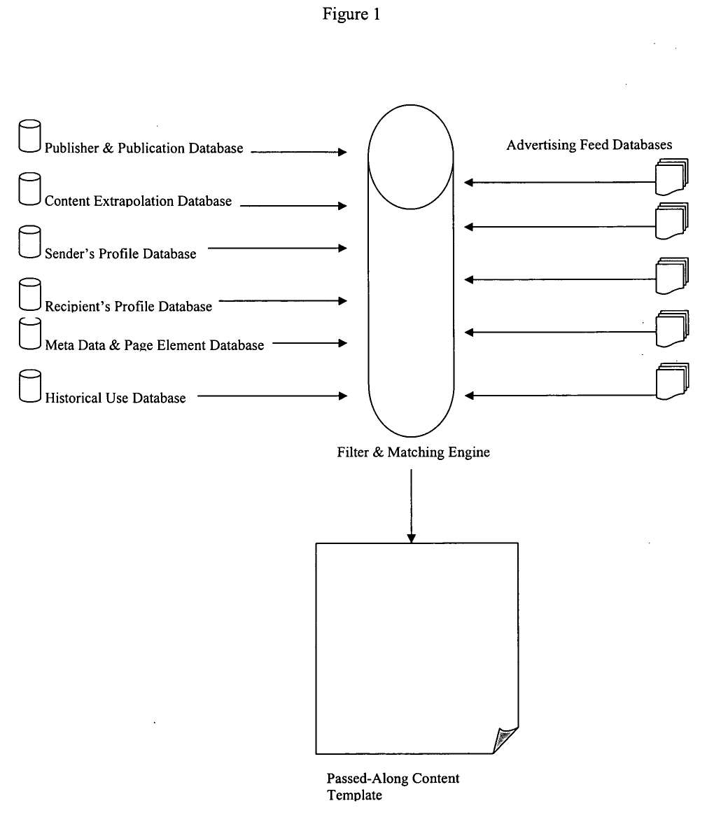

The invented system gathers and analyses data from several sources to determine which advertisements are to be inserted into the passed-along content or inserted into web published content to which links have been passed along and the prices to be charged for these ads. As shown in FIG. 1, the data elements include:
1) Identities of the publisher and the publication in which the content was published.
2) The subject and substance of the content itself.
3) Identity of the sender.
4) Identities of the intended recipients.
5) Other data, sometimes hidden, on the pages in which the content appears.
6) Historical data about prior uses of the content by the sender or intended recipients.
7) Historical data about prior uses of other content by the sender or intended recipients. For example, if we know that articles 1, 2, and 3 were all sent by user Joe, and that ads A, B, and C were all clicked on by Joe's recipients, then we can infer that ads A, B, and C may be of interest to recipients of the next article sent by Joe, even if we know nothing about that article—we know something about Joe's friends and how they use the content.

The system aggregates the data from these sources and matches it against the available inventory of advertisements provided by third parties. The matching process determines which advertisements in the inventory are most likely of interest to the recipients, and are inserted into the passed-along content. It is the combination of these multiple data sources with the available inventory of ads to ascertain the relevancy of the ads to the recipients of the passed-along content that makes the invented method unique and valuable.

By having a database with information about the publisher and publication in which the content was published, the invented system can extract keywords and other identifiers from fields maintained in the database. Fields that are maintained in the Publisher/Publication database may include, but are not limited to:
Type of publisher, i.e., magazine, newspaper, books, music, research paper, etc.
Categories of content published, i.e., business, sports, entertainment, political, international news, etc.
Audience profile, i.e., executives, technicians, attorneys, marketing professionals, etc.
Advertisers and their key messages
Circulation
Content contributors, i.e., technology writers, financial analysts, wildlife photographers, etc.

By having a database with information about the subject and substance of specific articles published by publishers, i.e., the content, the invented system can use artificial intelligence methods to make intelligent guesses about the interests of the sender and intended recipients for the passed along content, and thereby predict what advertising messages might be most effective. These artificial intelligence methods include algorithms that look for the frequency of keywords to help determine the context of the content, as well as categories of content such as business, entertainment, technical, etc, and other taxonomies and classifications.

By having a database with records about the sender and/or intended recipients and understanding the relationship between them, the invented system can make an intelligent guess about what advertising messages may interest the sender and/or the recipients. The fields that are stored about the sender and recipient may include, but are not limited to:
first name and last name
company name
title or role
address, city, state, zip
phone number
e-mail address
personal or company website address
demographics data such as male/female, age, income level, education level, hobbies, etc.
history of content passed along to others, ads acted upon, etc.

By examining this and other information surrounding the content, whether hidden or not hidden, the invented system can further deduce what advertisements would be more appropriate than other advertisements given the available inventory, to insert along with the passed-along content. The fields that are stored in the content metadata database may include, but are not limited to:
Content title
Content description or summary
Content author
Story ID tags (inserted by publishers and their content management systems to provide information to search engines and other tools about the story, so it can be found and categorized)
Content category, i.e., classifieds, business, features, archives, etc.
Advertising tags

By having an historical database of how the content was accessed, licensed and used by others, and which ads previously displayed with the content were acted upon (by click, phone call, or other means) by other recipients when passed-along under other circumstances, the invented method can make intelligent guesses about how relevant particular ads may be to others who are to view it as they pass it along or as they receive it. The fields stored in the historical database may include, but are not limited to:
The keywords, categories, taxonomies and classifications previously used to place the ads in the passed-along content
The number of clicks on a headline, abstract or other content descriptor
The ads that were clicked on that accompanied the content
The referrer, such as a search engine, IP address, another website, clipping service, or other in-bound link

Each of these data elements is weighted and combined to select a best match from the available inventory of advertisements, to select and insert the advertisements that are likely to be relevant to the content and of interest to the recipients. The advertisements that are thus inserted into the passed-along content may be text, links to web sites, images, or rich data, such as animation, video and audio when users mouse-over certain parts of the page. Advertisements may also be inserted into hardcopy versions of the content. Inherent in data element six, historical data about prior uses, is the ability of the invented method to track how many ads are acted upon and which ads are acted upon, which allows the invented system to make a new and better selection of an ad when the same piece of content is passed-along by other users or charge a higher price for the same ad.

The invented method provides a mechanism for the content to be passed along multiple times, inserting new advertisements at each step. For example, when User A e-mails the content to User B, advertisements are inserted that may appeal specifically to User A or User B. An embedded tag, rendered as a hyperlink, allows User B to pass-along the content to Users C, D, E, F, ad infinitum. The content that is received by Users C, D, E, F, ad infinitum from User B may include different advertisements, based upon the likely relevancy of those advertisements to each recipient. Each recipient can, in turn, pass the content on to even more people. The system tracks how the content was passed along, i.e., e-mail, print, or other form, the quantity passed, i.e., 50 copies, and in some cases, the profiles of the people who received it. The invented system tracks if the recipient clicked the advertisements, called the advertiser, or otherwise acted upon the advertisements. This data is shared with the publisher and the advertisers to determine performance, ad placement within the content, and ad rates, among other purposes.

The invented method also provides a mechanism for providing up-to-date, relevant ads for passed-along content at the time the content is consumed by the recipient, rather than at the time the content is sent by the sender. For example, at the time User A passes along an article to User B, the method may select ads 1 and 2 as being relevant, but reject ad 3 as being irrelevant. By the time User B reads the article, however, usage data about the article may imply that ad 3 is more relevant than ad 2, and therefore User B will be shown ads 1 and 3 instead. Similarly, changes in the inventory of the ads, information about the sender or the recipient, and so on could have similar impact.

The invention may be embodied with infinite variations. Thus, the scope of the invention shall be understood to be what is stated in the following claims without limitation by any particular embodiments or examples given above.

We claim:

1. A computer method for selecting advertising to accompany digital content published in a computer network system where users may pass along content to others, comprising:
(a) publishing an item of digital content on a publicly accessible computer network with a first accompanying advertisement having a price;
(b) receiving from a first user on the network, which user had previously received a copy of the item with the first advertisement, a request to convey a copy of the item to a second person;
(c) conveying the item to the second person without the first advertisement and with a second advertisement in its place and charging for the second advertisement a different price than the first advertisement.

2. The method of claim 1 where the copy is conveyed by the first user requesting that a link to the item be conveyed over the network to a computer for the second person and the second person receives the item as a result of selecting the link.

3. The method of claim 1 where the copy is conveyed by the system conveying a message containing the item over the network to a computer for the second person.

4. The method of claim 1 where the copy is conveyed by the system making a copy of the item available on a web page served by the system, which web page is associated with the first user, and then sending a message to the second person stating that one or more items selected by the first user are available from the web page.

5. The method of claim 4 where the message is sent to the second person by the first user.

6. The method of claim 4 where the message is sent to the second person by the system.

7. The method of claim 1 where the copy is conveyed to the second person by printing one or more copies on paper and sending the paper copies.

8. The method of claim 1 where the first user instructs the system to wait for a specified period of time and then convey a copy of the content to the second person.

9. The method of claim 1 where the second advertisement has a higher price than the first advertisement

10. The method of claim 1 where the second advertisement has a lower price than the first advertisement

11. The method of claim 1 where the prices are set in part as a function of information stored in the system about one or both of the first user and the second person.

12. A computer method for pricing advertising to accompany digital content published in a computer network system where users may pass along content to others, comprising:
(a) publishing an item of digital content on a publicly accessible computer network with an accompanying advertisement having a first price charged to an advertiser for presentation of the advertisement;
(b) receiving a request from a user on the network to convey a copy of the item to a second person;
(c) conveying a copy of the item to the second person with the advertisement and charging to the advertiser a second price for presentation of the advertisement which second price is different than the first price.

13. The method of claim 12 where the prices are set as a function of information stored in the system about one or both of the first user and the second person.

14. The method of claim 12 where a number of one or more requests are received, each requesting that a copy of the item be conveyed to one or more other people, and the second price is in part a function of the number of requests received.

15. The method of claim 12 where the copy is conveyed to the second person by the system printing a number of one or more hardcopies on paper and sending the paper copies.

16. The method of claim 15 where the price for advertisement presentation is based in part on the number of hardcopies printed.

17. The method of claim 12 where the price for advertisement presentation is based in part on sending the ad to a computer for viewing.

18. The method of claim 12 where the price for advertisement presentation is based in part on selection of the ad by a computer user.

19. The method of claim 12 where the second price for advertisement presentation is based in part on one or both of: length of time the item was saved in the system for access by the first user and number of viewings by the first user before the first user instructs the system to convey the item to the second user.

20. A computer method for pricing advertising to accompany digital content published in a computer network system where users may pass along content to others, comprising:
(a) publishing an item of digital content on a publicly accessible computer network;
(b) receiving a request from a first user on the network to convey a copy of the item to a second person;
(c) looking up in a database an identity of the first user; and
(d) conveying a copy of the item to the second person with an advertisement and automatically charging to an advertiser a price for presentation of the advertisement which price is a function of the identity of the first user.

21. The method of claim 20 where the identity of the first user is established from logon information entered to the network by the first user.

22. The method of claim 20 where the identity of the first user is established from a cookie stored in a computer used by the first user to access the network.

23. The method of claim 20 where the identity of the first user is established from a network address used by the first user.

24. The method of claim 20 where the price for advertisement presentation is based in part on a profile of the first user which profile was assembled from data about content items that have been acted upon previously by the first user.

25. The method of claim 24 where the profile was assembled by identifying content that was previously passed along by the first user.

26. The method of claim 25 where the content was identified by identifying the publisher and publication.

27. The method of claim 25 where the content was identified by identifying a particular subject addressed in a particular item of content previously passed along by the first user.

28. The method of claim 24 where the profile was assembled by identifying advertisements that were previously selected by the first user.

29. A computer method for selecting advertising to accompany digital content published in a computer network system where users may pass along content to others, comprising:
(a) publishing an item of digital content on a publicly accessible computer network;
(b) receiving a request from a first user on the network to convey a copy of the item to a second person;
(c) looking up in a database an identity of the first user; and
(d) conveying a copy of the item to the second person with an advertisement and automatically selecting the advertisement as a function of the identity of the first user.

30. The method of claim 29 where the advertisement selected for conveyance to the second person is based on a profile of the first user which profile was assembled from data about content items that have been acted upon previously by the first user.

31. The method of claim 30 where the profile was assembled by identifying advertisements that were previously selected by the first user.

32. A computer method for pricing advertising to accompany digital content published in a computer network system where users may pass along content to others, comprising:
(a) publishing an item of digital content on a publicly accessible computer network;
(b) receiving a request from a first user on the network to convey a copy of the item to a second person;
(c) looking up in a database an identity of the second person; and
(d) conveying a copy of the item to the second person with an advertisement and automatically charging to an advertiser a price for presentation of the advertisement which price is a function of the identity of the second person.

33. The method of claim 32 where the copy of the item is conveyed to a network address and the identity of the second person is established from logon information entered to the network associated with the network address.

34. The method of claim 32 where the copy of the item is conveyed to a network address and the identity of the second person is established from a cookie stored in a computer used by the second person to access the network.

35. The method of claim 32 where the copy of the item is conveyed to a network address and the identity of the second person is established from the network address.

36. The method of claim 32 where the identity of the second person is established by the first user identifying the second person by one or more of name, title, company, address, department, function, or relationship.

37. The method of claim 36 where the copy is conveyed to the second person by printing one or more copies on paper and sending the paper copies.

38. The method of claim 32 where the price for advertisement presentation is based on a profile of the second person which profile was assembled from data about content items that have been acted upon previously by the second person.

39. The method of claim 38 where the profile was assembled by identifying content that was previously passed along by the second person.

40. The method of claim 39 where the content was identified by identifying the publisher and publication.

41. The method of claim 39 where the content was identified by identifying a particular subject addressed in a particular item of content previously passed along by the second person.

42. The method of claim 38 where the profile was assembled by identifying advertisements that were previously selected by the second person.

43. A computer method for selecting advertising to accompany digital content published in a computer network system where users may pass along content to others, comprising:
(a) publishing an item of digital content on a publicly accessible computer network;
(b) receiving a request from a computer on the network with a first computer network address to convey a copy of the item to a second person;
(c) looking up in a database an identity of the second person; and
(d) conveying a copy of the item to the second person with an advertisement and automatically selecting the advertisement as a function of the identity of the second person.

44. The method of claim 43 where the selection of the advertisement for presentation is based on a profile of the second person which profile was assembled from data about content items that have been acted upon previously by the second person.
